(19) United States
(12) Patent Application Publication
(10) Pub. No.: US 2011/0037556 A1
(43) Pub. Date: Feb. 17, 2011

(54) PRINTED CIRCUIT BOARD

(75) Inventors: YU-CHANG PAI, Tu-Cheng (TW); PO-CHUAN HSIEH, Tu-Cheng (TW); CHIEN-HUNG LIU, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/562,153

(22) Filed: Sep. 18, 2009

(30) Foreign Application Priority Data
Aug. 11, 2009 (CN) 200910305503.9

(51) Int. Cl. H01F 5/00

(52) U.S. Cl. 336/200

(57) ABSTRACT

A printed circuit board includes a first layer, a second layer, a number of vias each passing through the first and second layers, and a number of transmission lines. Each transmission line is connected between bonding pads of the two of the number of vias to form a helical-shaped transmission path by the vias and the transmission lines. As a result, the printed circuit board can generate inductive effect.

### BACKGROUND

1. Technical Field

The present disclosure relates to a printed circuit board.

2. Description of Related Art

An inductor is a passive electrical component that can store energy in a magnetic field created by the electric current passing through the inductor. Inductors are one type of the basic electronic components used in electronic devices. Typically an inductor is a conducting wire shaped as a coil. However, a relatively large area of a printed circuit board of an electronic device is needed to mount the inductor on the printed circuit board, which is costly for manufacturing the electronic device.

### BRIEF DESCRIPTION OF THE DRAWINGS

FIG. 1 is an isometric view of a first embodiment of a printed circuit board.

FIG. 2 is a simulation graph of loss of a differential input for the printed circuit board of FIG. 1.

FIG. 3 is a simulation graph of loss of a common mode converted into a differential mode for the printed circuit board of FIG. 1.

FIG. 4 is a simulation graph of an inductance of the printed circuit board of FIG. 1.

FIG. 5 is an isometric view of a second embodiment of a printed circuit board.

### DETAILED DESCRIPTION

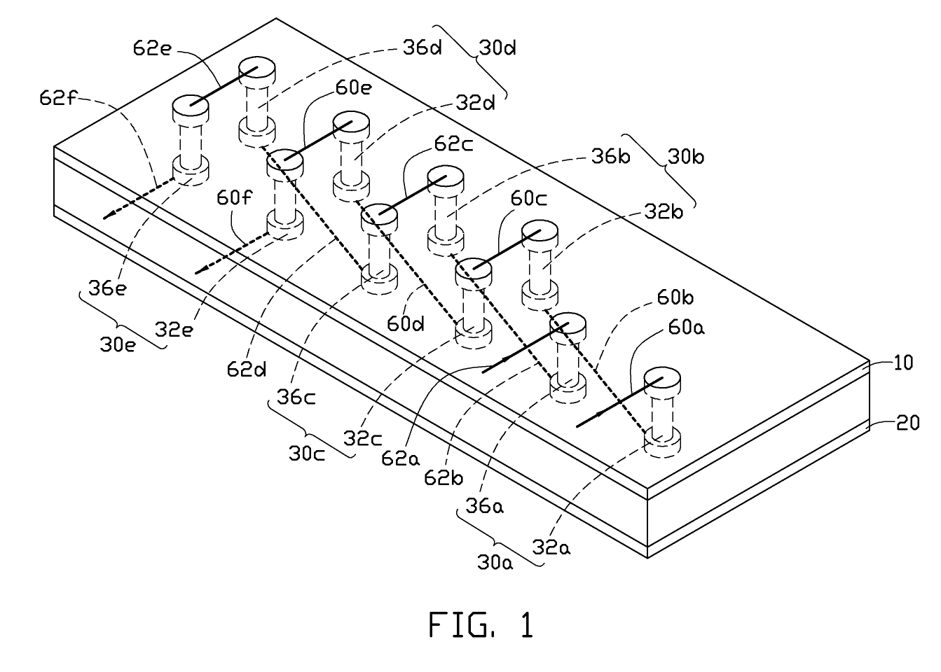

Referring to FIG. 1, a first exemplary embodiment of a printed circuit board 1 includes a first layer 10, a second layer 20, a plurality of pairs of vias, and a plurality of transmitting lines. Each pair of vias includes two vias. Each via connects the plurality of transmitting lines on the first layer 10 and the second layer 20. Each transmitting line is connected with bonding pads (not shown) of the plurality of vias. There is dielectric material arranged between the first layer 10 and the second layer 20.

In the first exemplary embodiment, the printed circuit board 1 includes five pairs of vias 30a-30e. It can be understood that in other embodiments, the printed circuit board 1 may include at least three pairs of vias.

The pair of vias 30a includes two vias 32a and 36a. The pair of vias 30b includes two vias 32b and 36b. The pair of vias 30c includes two vias 32c and 36c. The pair of vias 30d includes two vias 32d and 36d. The pair of vias 30e includes two vias 32e and 36e. The pairs of vias 30a, 30c, and 30e are arranged in a first array. The pairs of vias 30b and 30d are arranged in a second array which is parallel with the first array. The vias 32b and 32c are arranged in a first row. The vias 36b and 36c are arranged in a second row. The vias 32d and 32e are arranged in a third row. The vias 36d and 36e are arranged in a fourth row. The first, second, and third rows are parallel with the fourth row. The vias 32a and 36a function as input terminals of the printed circuit board 1. The vias 32e and 36e function as output terminals of the printed circuit board 1.

The transmission lines 60a and 62a are arranged on the first layer 10, and connected with the bonding pads of the vias 32a and 36a respectively.

The transmission line 60b is arranged on the second layer 20, and connected between the bonding pads of the vias 32a and 32b. The transmitting line 62b is arranged on the second layer 20, and connected between the bonding pads of the vias 36a and 36b.

The transmission line 60c is arranged on the first layer 10, and connected between the bonding pads of the vias 32b and 32c. The transmission line 62c is arranged on the first layer 10, and connected between the bonding pads of the vias 36b and 36c.

The transmission line 60d is arranged on the second layer 20, and connected between the bonding pads of the vias 32c and 32d. The transmission line 62d is arranged on the second layer 20, and connected between the bonding pads of the vias 36c and 36d.

The transmission line 60e is arranged on the first layer 10, and connected between the bonding pads of the vias 32d and 32e. The transmission line 62e is arranged on the first layer 10, and connected between the bonding pads of the vias 36d and 36e.

The transmission lines 60f and 62f are arranged on the second layer 20, and connected to the bonding pads of the vias 32e and 36e respectively.

In use, signals are input to the printed circuit board 1 through the transmission line 60a. The signals are transmitted from the first layer 10 to the second layer 20 through the via 32a. On the second layer 20, the signals are transmitted from the via 32a to the via 32b through the transmission line 60b, and then to the first layer 10 through the via 32b. On the first layer 10, the signals are transmitted from the via 32b to the via 32c through the transmission line 60c, and then to the second layer 20 through the via 32c. As a result, the signals are transmitted between the first layer 10 and the second layer 20 to form a helical-shaped transmission path which is shaped as a coil. Because of the helical-shaped transmission path, the printed circuit board 1 generates inductive effect.

In a similar way, the vias 36a-36e form a helical-shaped transmission path to generate inductive effect. In addition, between the helical-shaped transmission path of the vias 32a-32e and the helical-shaped transmission path of the vias 36a-36e, inductive effect can be generated. In an embodiment, the length of the helical-shaped transmission path of the vias 32a-32e is equal to the length of the helical-shaped transmission path of the vias 36a-36e.

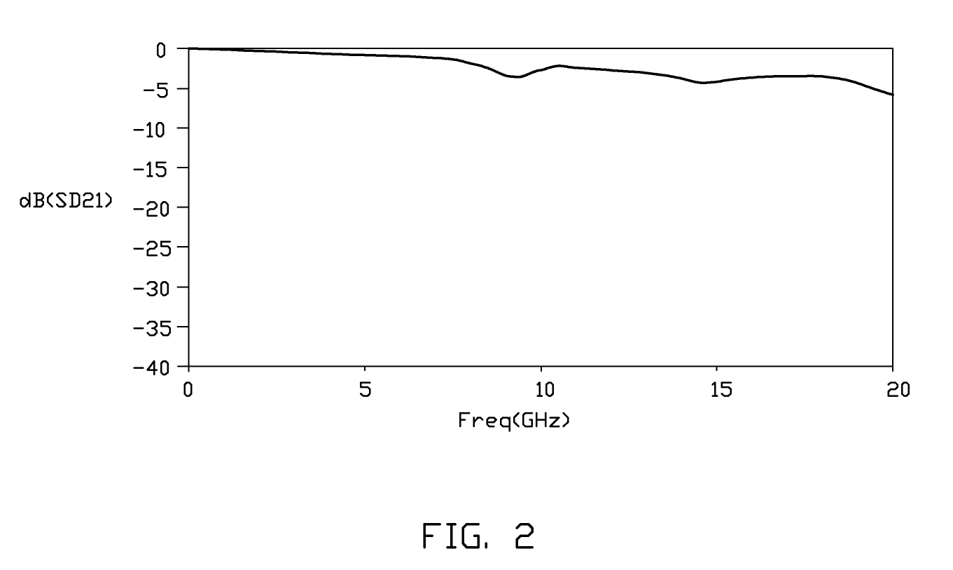

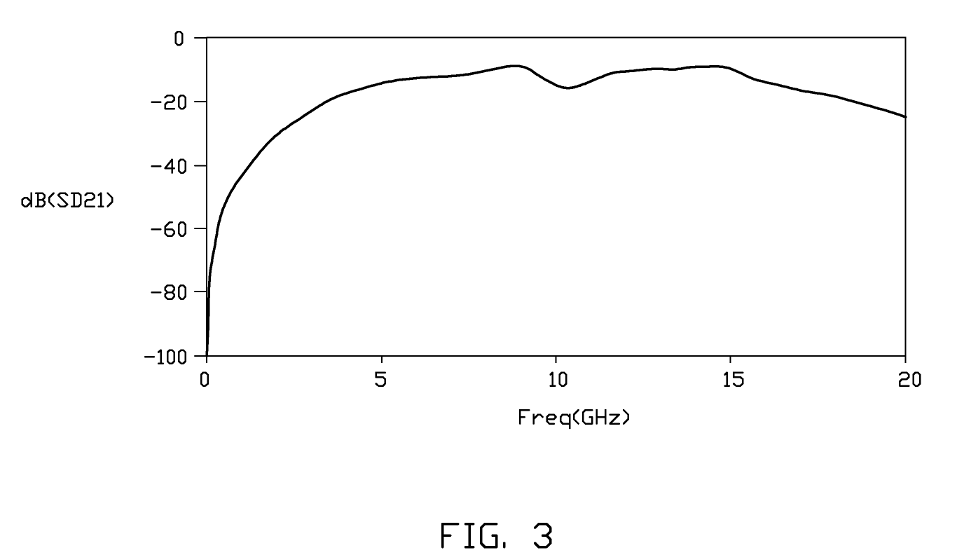

FIG. 2 is a graph showing a loss of a differential input for the printed circuit board 1. FIG. 3 is a graph showing a loss of a common mode converted into a differential mode for the printed circuit board 1. For FIGS. 2 and 3, the parameter of the printed circuit board 1 is set as follows: a distance between the vias 32a and 32b is equal to 80 mils, a radius of the via 32a is equal to 15 mils, a radius of the via 36a is equal to 10 mils, a distance between the vias 36a and 32c is equal to 40 mils, and a distance between the vias 32b and 32c is equal to 34.6 mils.

FIGS. 2 and 3 show that from a low frequency band to a high frequency band, the printed circuit board 1 has an excellent frequency response. In addition, the printed circuit board 1 can suppress common-mode noise effectively.

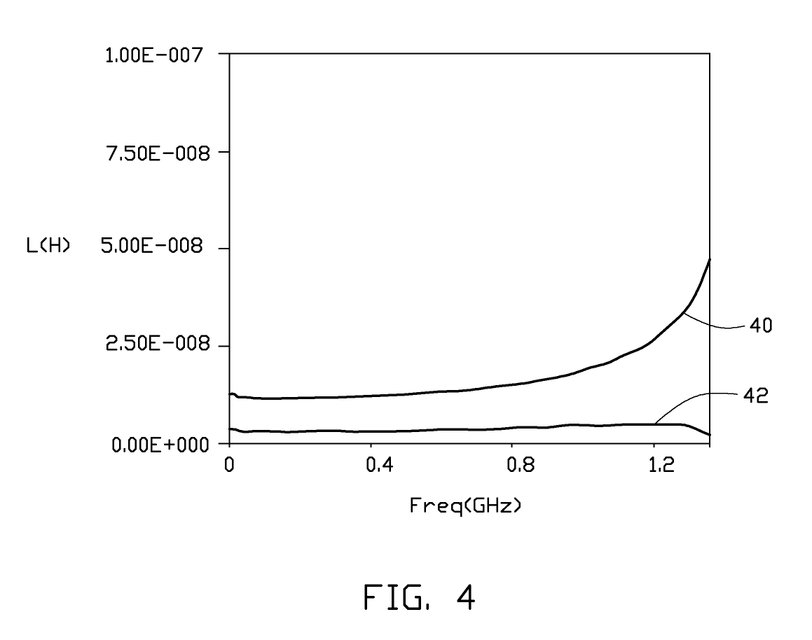

FIG. 4 is a graph showing an equivalent inductance of the printed circuit board 1. A curve 40 shows an equivalent inductance for each transmission path in the printed circuit board 1. A curve 42 shows an equivalent inductance between the two transmission paths in the printed circuit board 1. FIG. 4 shows that from a low frequency band to a high frequency band, the printed circuit board 1 can generate inductive effect.

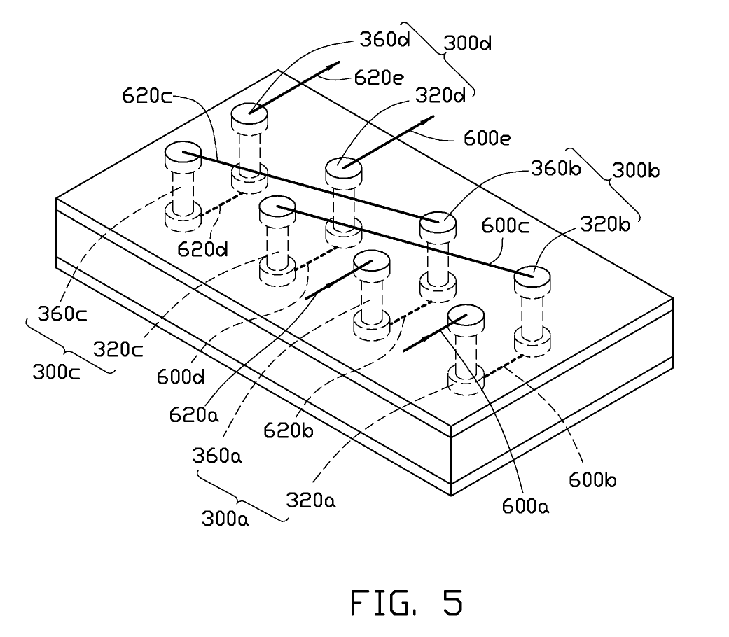

Referring to FIG. 5, a second exemplary embodiment of a printed circuit board 2 includes a first layer 100, a second layer 200, four pairs of vias 300a-300d, and a plurality of transmission lines.

The pair of vias 300a includes two vias 320a and 360a. The pair of vias 300b includes two vias 320b and 360b. The pair of vias 300c includes two vias 320c and 360c. The pair of vias 300d includes two vias 320d and 360d. The vias 320a, 360a, 320c, and 360c are arranged in a first array. The vias 320b, 360b, 320d, and 360d are arranged in a second array which is parallel with the first array. The vias 320a and 320b are arranged in a first row. The vias 360a and 360b are arranged in a second row. The vias 320c and 320d are arranged in a third row. The vias 360c and 360d are arranged in a fourth row. The first row, second row, and third row are parallel with the fourth row. The vias 320a and 360a function as the input terminals of the printed circuit board 2. The vias 320d and 360d function as output terminals of the printed circuit board 2.

The transmission lines 600a and 620a are arranged on the first layer 100, and connected to the bonding pads of the vias 320a and 360a.

The transmission line 600b is arranged on the second layer 200, and connected between the bonding pads of the vias 320a and 320b. The transmission line 620b is arranged on the second layer 200, and connected between the bonding pads of the vias 360a and 360b.

The transmission line 600c is arranged on the first layer 100, and connected between the bonding pads of the vias 320b and 320c. The transmission line 620c is arranged on the first layer 100, and connected between the bonding pads of the vias 360b and 360c.

The transmission line 600d is arranged on the second layer 200, and connected between the bonding pads of the vias 320c and 320d. The transmission line 620d is arranged on the second layer 200, and connected with the bonding pads of the vias 360c and 360d.

The transmission lines 600e and 620e are arranged on the first layer 100, and connected to the bonding pads of the vias 320d and 360d respectively.

In the similar way of the first embodiment, the printed circuit board 2 can generate inductive effect.

In other embodiments, the printed circuit board may include the vias 32a-32e or 320a-320d. As a result, the printed circuit board generates inductive effect with the helical-shaped transmission path of the vias 32a-32e or the vias 320a-320d. In addition, the vias 32a-32e, 36a-36e, 320a-320d, or 360a-360d can be arranged in other modes to form the helical-shaped transmission path.

The foregoing description of the exemplary embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A printed circuit board comprising:
a first layer;
a second layer;
a plurality of vias each passing through the first and second layers; and
a plurality of transmission lines each connected between bonding pads of two of the plurality of vias, to form a helical-shaped transmission path by the plurality of vias and the transmission lines.

2. The printed circuit board of claim 1, wherein some of the plurality of vias are arranged in a first array and others of the plurality of vias are arranged in a second array, the first array is parallel with the second array, the number of the vias in the first array is equal to the number of the vias in the second array, every two adjacent vias in the first array and in the second array are arranged in a row; wherein a bonding pad of a via in the first array on the first layer and a bonding pad of a via in the second array on the first layer at opposite sides of a row of vias are connected through a corresponding transmission line of the plurality of transmission lines; wherein two vias in a row on the second layer are connected together through a corresponding transmission line of the plurality of transmission lines.

3. The printed circuit board of claim 2, wherein the plurality of vias comprises a first to an eighth vias, the first, third, fifth, and seventh vias are arranged in the first array, the second, fourth, sixth, and eighth vias are arranged in the second array, the first and second vias are arranged in a first row, the third and fourth vias are arranged in a second row, the fifth and sixth vias are arranged in a third row, the seventh and eighth vias are arranged in a fourth row; wherein a bonding pad of the first via on the first layer is connected with a bonding pad of the sixth via on the first layer through a corresponding transmission line, a bonding pad of the third via on the first layer is connected with a bonding pad of the eighth via on the first layer through a corresponding transmission line; wherein a bonding pad of the first via on the second layer is connected with a bonding pad of the second via on the second layer through a corresponding transmission line, a bonding pad of the third via on the second layer is connected with a bonding pad of the fourth via on the second layer through a corresponding transmission line, a bonding pad of the fifth via on the second layer is connected with a bonding pad of the sixth via on the second layer through a corresponding transmission line, a bonding pad of the seventh via on the second layer is connected with a bonding pad of the eighth via on the second layer through a corresponding transmission line.

4. The printed circuit board of claim 1, wherein some of the plurality of vias are arranged in a first array and others of the plurality of vias are arranged in a second array, the first array is parallel with the second array, the number of the vias in the first array is equal to the number of the vias in the second array, every two adjacent vias in the first array and in the second array are arranged in a row; wherein a bonding pad of a via in the first array on the first layer and a bonding pad of a via in the second array on the first layer of two adjacent rows of vias are connected through a corresponding transmission line of the plurality of transmission lines; wherein two vias in a row on the second layer are connected together through a corresponding transmission line of the plurality of transmission lines.

5. The printed circuit board of claim 4, wherein the plurality of vias comprises a first to a fourth vias, the first and third vias are arranged in the first array, the second and fourth vias are arranged in the second array, the first and second vias are arranged in a first row, the third and fourth vias are arranged in a second row; wherein a bonding pad of the first via on the first layer is connected with a bonding pad of the fourth via on the first layer through a corresponding transmission line; wherein a bonding pad of the first via on the second layer is connected with a bonding pad of the second via on the second layer through a corresponding transmission line, a bonding pad of the third via on the second layer is connected with a bonding pad of the fourth via on the second layer through a corresponding transmission line.

6. The printed circuit board of claim 1, wherein some of the plurality of vias are arranged in a first array and others of the plurality of vias are arranged in a second array, the first array is parallel with the second array, the number of the vias in the first array is M, and the number of the vias in the second array is N, N=M+2, the vias in the first array are arranged in M rows with M vias of the vias in the second array; wherein two vias in a row on the first layer are connected together through a corresponding transmission line; wherein a bonding pad of a via in the first array on the second layer and a bonding pad of a via in the second array on the second layer at opposite sides of a row of vias are connected through a corresponding transmission line.

7. The printed circuit board of claim 6, wherein the plurality of vias comprises a first to a tenth vias, the first, third, fifth, and seventh vias are arranged in the first array, the second, fourth, sixth, eighth, ninth, and tenth vias are arranged in the second array, the first and second vias are arranged in a first row, the third and fourth vias are arranged in a second row, the fifth and sixth vias are arranged in a third row, the seventh and eighth vias are arranged in a fourth row, the ninth and tenth vias are located at a side of the second via; wherein a bonding pad of the first via on the first layer is connected with a bonding pad of the second via on the first layer through a corresponding transmission line, a bonding pad of the third via on the first layer is connected with a bonding pad of the fourth via on the first layer through a corresponding transmission line, a bonding pad of the fifth via on the first layer is connected with a bonding pad of the sixth via on the first layer through a corresponding transmission line, a bonding pad of the seventh via on the first layer is connected with a bonding pad of the eighth via on the first layer through a corresponding transmission line; wherein a bonding pad of the first via on the second layer is connected with a bonding pad of the tenth via on the second layer through a corresponding transmission line, a bonding pad of the third via on the second layer is connected with a bonding pad of the ninth via on the second layer through a corresponding transmission line, a bonding pad of the fifth via on the second layer is connected to a bonding pad of the second via on the second layer through a corresponding transmission line, a bonding pad of the seventh via on the second layer is connected with a bonding pad of the fourth via on the second layer via a corresponding transmission line.

8. The printed circuit board of claim 6, wherein the plurality of vias comprises a first to a sixth vias, the first and third vias are arranged in the first array, the second, fourth, fifth, and sixth vias are arranged in the second array, the first and second vias are arranged in a first row, the third and fourth vias are arranged in a second row, the fifth via is located at a side of the second via opposite to the fourth via, the sixth via is located at a side of the fifth via opposite to the second via; wherein a bonding pad of the first via on the first layer is connected with a bonding pad of the second via on the first layer through a corresponding transmission line, a bonding pad of the third via on the first layer is connected with a bonding pad of the fourth via on the first layer through a corresponding transmission line; wherein a bonding pad of the first via on the second layer is connected with a bonding pad of the sixth via on the second layer through a corresponding transmission line, a bonding pad of the third via on the second layer is connected with a bonding pad of the fifth via on the second layer through a corresponding transmission line.

9. The printed circuit board of claim 1, wherein the some of the plurality of vias are arranged in a first array and others of the plurality of vias are arranged in a second array, the first array is parallel with the second array, the number of the vias in the first array is M, and the number of the vias in the second array is N, N=M+1, the vias in the first array are arranged in M rows with M vias of the vias in the second array; wherein two vias in a row on the first layer are connected together through a corresponding transmission line; wherein a bonding pad of a via in the first array on the second layer and a bonding pad of a via in the second array on the second layer of two adjacent rows of vias are connected through a corresponding transmission line.

10. The printed circuit board of claim 9, wherein the plurality of vias comprises a first to a fifth vias, the first and third vias are arranged in the first array, the second, fourth, and fifth vias are arranged in the second array, the first and second vias are arranged in a first row, the third and fourth vias are arranged in a second row, the fifth via is located at a side of the second via opposite to the fourth via; wherein a bonding pad of the first via on the first layer is connected with a bonding pad of the second via on the first layer through a corresponding transmission line, a bonding pad of the third via on the first layer is connected with a bonding pad of the fourth via on the first layer through a corresponding transmission line; wherein a bonding pad of the first via on the second layer is connected with a bonding pad of the fifth via on the second layer through a corresponding transmission line, a bonding pad of the third via on the second layer is connected with a bonding pad of the second via on the second layer through a corresponding transmission line.
